(19) United States
(12) Patent Application Publication
(10) Pub. No.: US 2025/0187774 A1
(43) Pub. Date: Jun. 12, 2025

(54) FILM CUTTING APPARATUS AND METHOD FOR CUTTING CONTAINER COVER FILM USING SAME

(71) Applicant: SEEGENE, INC., Seoul (KR)

(72) Inventors: Hyun Jin LIM, Seoul (KR); Deog Pill CHO, Seoul (KR); Yoojun HAN, Seoul (KR); Won Seok JEONG, Seoul (KR)

(21) Appl. No.: 18/841,116

(22) PCT Filed: Feb. 22, 2023
(86) PCT No.: PCT/KR2023/002508

§ 371 Date: Aug. 23, 2024

(30) Foreign Application Priority Data
Feb. 25, 2022 (KR) 10-2022-0025134

(51) Int. Cl. B65B 61/08; B26D 1/18; B26D 5/02; B26D 7/02

(52) U.S. Cl. CPC B65B 61/08; B26D 1/185; B26D 5/02; B26D 7/025

(57) ABSTRACT

A film cutting device for cutting a cover film attached to a container including a plurality of chambers that are detachably connected to each other includes a base frame, a pressing module, a transfer module, and a cutting module. The pressing module is coupled to the base frame to be movable in a vertical direction, and is configured to move down and press downward the chambers located in both lateral portions of the container. The transfer module is coupled to at least one of the pressing module and the base frame. The cutting module is coupled to transfer module. The cutting module includes a plurality of cutting means capable of cutting the cover film attached to the container, and the transfer module is configured to move the cutting module in a longitudinal direction so that the cover film is cut while the pressing module presses the chamber of the container.

### FIELD

Embodiments relate generally to a film cutting device and a method of cutting a cover film of a container using film cutting device.

This patent application claims priority under Article 119(a) of the U.S. Patent Act (35 U.S.C § 119 (a)) for Korean Patent Application No. 10-2022-0025134 filed in Korea on Feb. 25, 2022. All contents are hereby incorporated by reference into this patent application.

### BACKGROUND

Recently, as people's life expectancy has increased and an interest in health has increased, a demand for a genetic analysis, a base sequence analysis, a disease diagnosis, etc. has increased. In general, in order to analyze a genetic information of nucleic acids for a purpose of the genetic analysis, the base sequence analysis, the disease diagnosis, etc., the nucleic acids are extracted from biological samples and analyzed.

A sample preparation process such as a nucleic acid extraction is mainly performed using an automated liquid handling device, and reagents used for the nucleic acid extraction are mainly provided using a cartridge-type container.

A plurality of chambers capable of accommodating the reagent used for the nucleic acid extraction are formed in a container for the nucleic acid extraction, and a reagent used for each stage of the nucleic acid extraction is accommodated in each of the plurality of chambers. In addition, when the reagent for the nucleic acid extraction is accommodated in each of the plurality of chambers, the plurality of chambers are sealed with a film, etc. to prevent the reagent for the nucleic acid extraction from leaking. After each of the plurality of chambers is sealed, the container is provided to a user, and the container is opened and used just before being mounted on the liquid handling device.

The reagents for the nucleic acid extraction included in each of the plurality of chambers of the container for the nucleic acid extraction may be exhausted at different rates depending on the user's extraction protocol. Therefore, each of the plurality of chambers of the container for the nucleic acid extraction may be configured to be separable so that only the exhausted chamber may be replaced. To this end, it is preferable that the container is manufactured so that the film sealing each of the plurality of chambers may be individually removed. However, if the plurality of chambers are individually sealed during a process of sealing the container, a sealing degree of the film may be different for each of the plurality of chambers. In this case, each of the plurality of chambers have a different sealing state, and a difference in the sealing degree of between the chambers may occur. In addition, if the plurality of chambers are individually sealed, it takes a lot of time to seal different films in each of the plurality of chambers. In this case, a sealing process becomes complicated, and a production efficiency is decreased.

Accordingly, a method has been recently developed for manufacturing a plurality of containers sealed with a film by sealing the plurality of chambers of the container with a single film and then cutting the single film. However, when the plurality of chambers are sealed with the single film, an upper portion of a gap between the plurality of chambers sealed with the single film becomes narrower due to a heat shrinkage of the single film, and a lower portion, which is opposite to the upper portion, of the gap becomes wider. In this case, it is difficult to cut the single film sealing the plurality of chambers, and the single film is not cut precisely.

Therefore, there is a need for a device capable of precisely cutting the single film sealing the plurality of chambers while simplifying the sealing process and improving a production efficiency by sealing the plurality of chambers with the single film and then cutting the single film.

### SUMMARY

Embodiments provide a film cutting device capable of improving a production efficiency by simplifying a sealing process as the single film is cut after a plurality of chambers are sealed with a single film.

Embodiments provide a film cutting device capable of precisely cutting the single film sealing the plurality of chambers.

According to embodiments of the present disclosure, a film cutting device for cutting a cover film attached to a container including a plurality of chambers that are detachably connected to each other includes a base frame, a pressing module, a transfer module, and a cutting module. The pressing module is coupled to the base frame to be movable in a vertical direction, and is configured to move down and press downward the chambers located in both lateral portions of the container. The transfer module is coupled to at least one of the pressing module and the base frame. The cutting module is coupled to transfer module. The cutting module includes a plurality of cutting means capable of cutting the cover film attached to the container, and the transfer module is configured to move the cutting module in a longitudinal direction so that the cover film is cut while the pressing module presses the chamber of the container.

In embodiments, the plurality of chambers may be connected to each other so that the plurality of chambers are arranged in a transverse direction.

In embodiments, the cutting module may further include a supporter supporting the plurality of cutting means. Each of the plurality of cutting means may include a cutting frame supported from the supporter to be able to move up and down with respect to the supporter and a cutting blade supported from the cutting frame.

In embodiments, the plurality of cutting means may be spaced apart from each other and may be supported from the supporter so that the plurality of cutting means are independently move up and down relative to each other.

In embodiments, the cutting module may further include a plurality of elastic member providing a restoring force to the cutting frame so that the cutting blade is pressed toward the container.

In embodiments, one side of the elastic member may be supported from the supporter, and other side of the elastic member may be supported from the cutting frame.

In embodiments, a stopper may be provided to at least one of the cutting frame and the supporter, and the stopper may prevent the cutting frame from being separated from the supporter.

In embodiments, the stopper may be protruded upward from the cutting frame, and may be supported from the supporter when the cutting frame is relatively moved down with respect to the supporter.

In embodiments, the cutting blade may be supported from the cutting frame so that the cutting blade is rotatable.

In embodiments, the cutting module may be moved forward so that the cover film is cut from a rear end of the cover film, and the cutting blade may move up more when cutting the cover film between the plurality of chambers than when cutting the rear end of the cover film.

In embodiments, while the cutting module is moved forward, the cutting blade may cut a part of the rear end of the cover film and may be rotated by being in contact with an upper end of the chamber.

In embodiments, the cutting blade may include a cutting edge provided at an end of the cutting blade and an inclined surface extending from the cutting edge toward a rotation axis of the cutting blade. The inclined surface may be inclined with respect to a direction that is perpendicular to a direction of the rotation axis. When the cutting edge cuts the cover film, the inclined surface may be in contact with the upper end of the chamber.

In embodiments, the cutting blade may have a circular shape.

In embodiments, the pressing module may include a plurality of pressing members and a pressing frame. The plurality of pressing members may be spaced apart from each other along a transverse direction of the cutting means, and may be capable of pressing an upper portion of the cover film. The pressing frame may support the plurality of pressing members, and may be configured to be movable in the vertical direction on the base frame. The plurality of pressing members may press the cover film attached to the chambers located in both lateral portions of the container, when the pressing frame moves down.

In embodiments, the plurality of cutting means may be spaced apart from each other by a predetermined distance between the plurality of pressing members so that each of the cutting blades is located between the chambers.

In embodiments, the plurality of pressing members may extend along the longitudinal direction, and each of the plurality of pressing members may have a flat shape.

In embodiments, the plurality of chambers may be arranged in a transverse direction, and the cutting blade may be configured to cut the cover film with a part of the cutting blade inserted between the plurality of chambers.

According to embodiments of the present disclosure, a method of cutting a cover film of a container includes (a) a preparation step of positioning a container in a film cutting device, (b) a pressing step of pressing the chambers located in both lateral portions of the container by moving down the pressing module, and (c) a cutting step of cover film attached to the container after the cutting module is moved by the transfer module. The container includes a plurality of chambers that are detachably connected to each other, and the film cutting device include a base frame, a pressing module, a transfer module, and a cutting module. The pressing module is coupled to the base frame to be movable in a vertical direction, and is configured to move down and press downward the chambers located in both lateral portions of the container. The transfer module is coupled to at least one of the pressing module and the base frame. The cutting module is coupled to transfer module. The cutting module includes a plurality of cutting means capable of cutting the cover film attached to the container, and the transfer module is configured to move the cutting module in a longitudinal direction so that the cover film is cut while the pressing module presses the chamber of the container.

In embodiments, (c) the cutting step may be performed after (b) the pressing step.

In embodiments, (c) the cutting step may include a first cutting step where the cutting module cuts a rear end of the cover film and a second cutting step where the cutting module cuts the cover film between the plurality of chambers. The cutting module may be moved forward so that the cover film is cut from the rear end of the cover film, and may include a cutting blade. The cutting blade may move up more in the second cutting step than the first cutting step.

In embodiments, the cutting blade may be spaced apart from the chamber in the first cutting step, and may be rotated by being in contact with an upper end of the chamber in the second cutting step.

In embodiments, the pressing module may include a plurality of pressing members spaced apart from each other along a transverse direction of the cutting means, and the container may include a plurality of chambers arranged in the transverse direction. In (b) the pressing step, the plurality of pressing members may press the cover film attached to chambers, which is located in both lateral portions of the container, among the plurality of chambers by moving down the plurality of pressing members.

In embodiments, in (c) the cutting step, the transfer module may move the cutting module between the plurality of pressing members, and may cut the cover film attached to the container.

In the film cutting device according to the embodiments of the present disclosure, as a single film is cut after the plurality of chambers are sealed with the single film, a process may be simplified, and a production efficiency is improved.

In addition, the film cutting device according to the embodiments of the present disclosure may precisely cut a film sealing the plurality of chambers.

### BRIEF DESCRIPTION OF THE DRAWINGS

Embodiments can be understood in more detail from the following description taken in conjunction with the accompanying drawings.

FIG. 1 is a perspective view illustrating a cover film cutting system according to embodiments of a present disclosure.

FIG. 2 is a block diagram conceptually illustrating a transfer module, a diving unit, and a controller, and of a film cutting device according to embodiments of a present disclosure.

FIG. 3 is a perspective view illustrating the film cutting device of FIG. 1.

FIG. 4 is a perspective view illustrating a cutting module of FIG. 1.

FIG. 5 is a cross-sectional view illustrating line I-I′ of FIG. 4.

FIG. 6 is a rear view and a partially enlarged view of FIG. 4.

FIG. 7 is a partially perspective view illustrating the film cutting device and a cartridge of FIG. 1.

FIG. 8 is a side view of FIG. 7.

FIG. 9 is a rear view of FIG. 7.

FIG. 10 is a diagram illustrating a state where a cutting mean rises with respect to a supporter of FIG. 8.

FIG. 11 is a rear view and a partially enlarged view of FIG. 10.

FIG. 12 is a flow chart illustrating a method of cutting a cover film of a container according to embodiments of a present disclosure.

FIG. 13 is a flow chart sequentially illustrating a cutting step of FIG. 12.

### DETAILED DESCRIPTION OF THE EMBODIMENTS

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, or ‘supplied’ to another element, it should be understood that the element may be directly connected to, supported by, or, supplied to another element, but that other elements may exist in the middle.

The terms used in the present specification are only used for describing specific embodiments, and are not intended to limit the present disclosure. Singular expressions include plural expressions unless the context clearly indicates otherwise.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

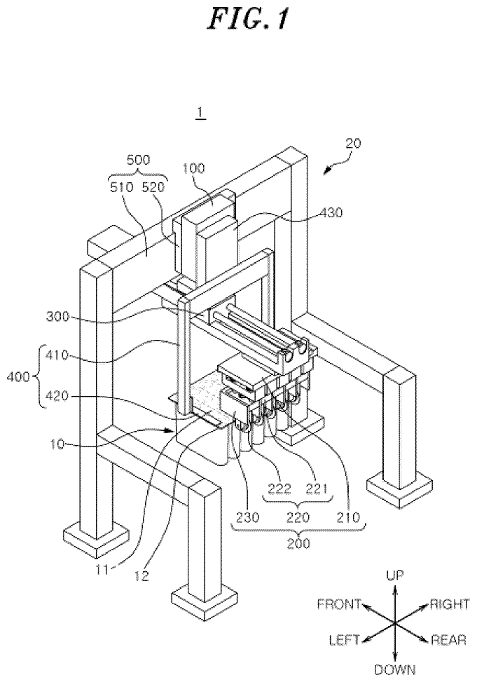

A longitudinal direction, a transverse direction, and a vertical direction used in the present specification mean directions that are perpendicular to each other. That is, each of the directions is orthogonal to each other. The longitudinal direction, the transverse direction, and the vertical direction used in the present specification are similar to the Cartesian coordinate system that is generally used to define three-dimensional directions. The expressions of directions such as the longitudinal direction, the transverse direction, and the vertical direction in the present specification are described based on the drawings and may be differently expressed if the direction of the corresponding object changes. In other words, these directions may be interchangeably used when referring to the three-dimensional directions of components. Meanwhile, the longitudinal direction, the transverse direction, and the vertical direction used in the present specification may be the direction of the coordinate axis shown in FIG. 1. For example, the longitudinal direction in the present specification may be a front-back direction of the coordinate axis shown in FIG. 1. In addition, the transverse direction in the present specification may be a left-right direction of the coordinate axis shown in FIG. 1. Further, the vertical direction in the present specification may be an up-down direction of the coordinate axis shown in FIG. 1.

Hereinafter, a specific configuration of a cover film cutting system 1 according to embodiments of the present disclosure will be described with reference to the drawings.

Referring to FIG. 1, the cover film cutting system 1 according to embodiments of the present disclosure may include a container 10 and a film cutting device 20.

The container 10 may accommodate a reagent for a nucleic acid extraction. For example, the container 10 may be a cartridge. In addition, the container 10 may be transported while accommodating the nucleic acid extraction reagent. The container 10 may include a chamber 11 and a cover film 12.

The chamber 11 may accommodate the reagent for the nucleic acid extraction, and may include a plurality of chambers 11. The plurality of chambers 11 may be connected to each other so that the plurality of chambers 11 are arranged in a transverse direction, and the plurality of chambers 11 may be detachably connected to each other. In addition, the plurality of chambers 11 may be sealed with the cover film 12 so that the reagent for the nucleic acid extraction accommodated in an inside of each of the plurality of chambers 11 is not leaked to an outside. For example, the reagent for the nucleic acid extraction accommodated in the chamber 11 refers to a reagent used to extract a nucleic acid from a sample. The reagent for the nucleic acid extraction may be separately accommodated in each of the plurality of chambers 11. For example, the reagent for the nucleic acid extraction may include one or more of a lysis buffer that lyses cells in the sample to expose the nucleic acid, a binding buffer that combines the exposed nucleic acid molecule with a solid particle, a washing buffer that is not substantially affected in the combination of the solid particle and the nucleic acid molecule, and an elution buffer that separates the nucleic acid molecule from the solid particles.

In the present specification, the term “sample” may include a biological sample (e.g., cells, tissues, and fluids from biological sources) and a non-biological sample (e.g., food, water, and soil). In addition, the biological sample may include viruses, bacteria, tissues, cells, blood (e.g., whole blood, plasma, and serum), lymph, bone marrow fluid, saliva, sputum, swabs, aspirations, milk, urine, feces, eye fluid, semen, brain extracts, spinal fluid, joint fluid, thymus fluid, bronchial washings, ascites, and amniotic fluid.

The cover film 12 may seal the plurality of chambers 11. For example, the cover film 12 may be adhered to an upper portion of each of the plurality of chambers 11 to seal the plurality of chambers 11, so that the inside of each of the plurality of chambers 11 may be blocked from an outside of the plurality of chambers 11. Here, a meaning of the cover film 12 sealing the plurality of chambers 11 may be understood as a state where the inside and outside of the plurality of chambers 11 are blocked by the cover film 12, so that there is not an inflow or outflow of a fluid into the plurality of chambers 11. The cover film 12 may be cut into multiple pieces by a film cutting device 20. In addition, when the cover film 12 is cut by the film cutting device 20, the plurality of chambers 11 may be separated from each other.

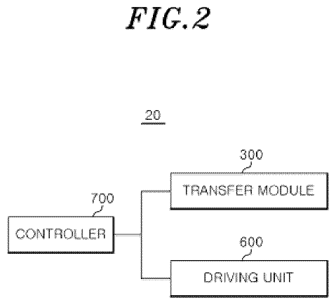

Referring to FIGS. 1 and 2, the film cutting device 20 may cut the cover film 12. The film cutting device 20 may include a base frame 100, a cutting module 200, a transfer module 300, a pressing module 400, a guide unit 500, a driving unit 600, and a controller 700.

The base frame 100 may support the cutting module 200, the transfer module 300, and the pressing module 400. In addition, the base frame 100 is movably supported on the guide unit 500, and a movement in the transverse direction may be guided by the guide unit 500. The base frame 100 together with the cutting module 200, the transfer module 300, and the pressing module 400 may be moved in the transverse direction. For example, the base frame 100 may be moved by the driving unit 600. As another example, the base frame 100 may be fixed and supported on the guide unit 500. If the position movement in the transverse direction of the base frame 100 is used only for a purpose of a setting a reference position in the transverse direction of the cutting module 200 according to the a cutting position of the container 10 and the cover film 12, the base frame 100 moves when a device is initially set up, and there is no need to move in the transverse direction during a cutting process of the cover film 12 of the container 10. Accordingly, the base frame 100 may be fixed and supported on the guide unit 500 without moving by a power of the driving unit 600. In this case, the cutting module 200 may cut the cover film 12 by moving in a longitudinal direction while a position of the cutting module 200 in the transverse direction is fixed.

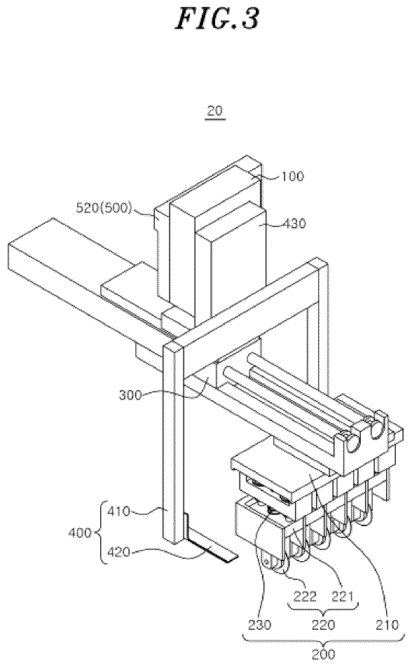

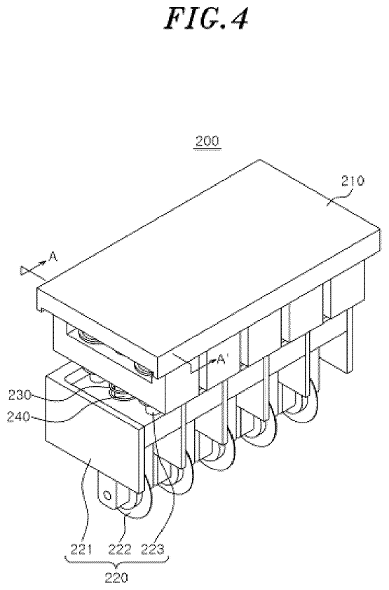

Referring to FIGS. 3 and 4, the cutting module 200 may cut the cover film 12 into multiple pieces. The cutting module 200 may be moved along the longitudinal direction by the transfer module 300. For example, the cutting module 200 may cut the cover film 12 while the cutting module 200 is moved from a rear end of the container 10 to a front end of the container 10. The cutting module 200 may include a supporter 210, a cutting mean 220, an elastic member 230, and a stopper 240.

The supporter 210 may be configured to be movable so that the cutting mean 220 cuts the cover film 12. The supporter 210 may be supported from the transfer module 300, and the supporter 210 may be moved in the longitudinal direction by the transfer module 300. For example, the supporter 210 may be moved along the longitudinal direction while the supporter 210 supports the cutting mean 220. In addition, the supporter 210 may support a plurality of cutting means 220. The cutting mean 220 supported from the supporter 210 may be configured to be relatively movable with respect to the supporter 210.

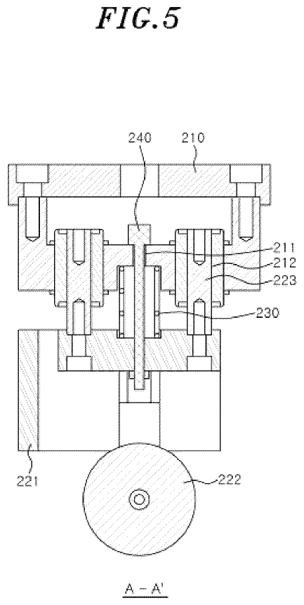

Referring to FIG. 5, a support hole 211 may be formed in the supporter 210, and the stopper 240 may penetrate the support hole 211. The support hole 211 may penetrate the supporter 210 along a vertical direction. In addition, the stopper 240 may be inserted into the support hole 211, and a width of the support hole 211 may be greater than a diameter of the stopper 240.

A guide hole 212 may be provided as a plurality of guide holes 212, and the plurality of guide holes 212 may be disposed in a front of the support hole 211 and a rear of the support hole 211. The guide hole 212 may penetrate the supporter 210 along the vertical direction. In addition, a guide pin 223, which will be described below, may be inserted into the guide hole 212.

The cutting mean 220 may cut the cover film 12 of the container 10. The cutting mean 220 may be supported from the supporter 210 so that the cutting mean 220 is relatively movable in the vertical direction with respect to the supporter 210. For example, the cutting mean 220 together with the supporter 210 may be moved down while the cutting mean 220 is supported from the supporter 210, and the cutting mean 220 may relatively rise with respect to the supporter 210 when cutting the cover film 12.

The cutting mean 220 may be placed in a first position while not cutting the cover film 12. Here, the first position of the cutting mean 220 may be a position where a cutting blade 222, which will be described below, is furthest away from the supporter 210, the first position of the cutting mean 220 means a relative position with respect to the supporter 210. For example, when the cutting mean 220 is moved in the longitudinal direction without being moved up or being moved down with respect to the supporter 210, the cutting mean 220 may be maintained in the first position. In addition, when the cutting mean 220 is placed in the first position, the stopper 240 may be maintained in a position while being caught on the supporter 210, and the elastic member 230 may be decompressed.

In addition, the cutting mean 220 may be provided as a plurality of cutting means 220, and the plurality of cutting means 220 may be supported from the supporter 210 so that the plurality of cutting means 220 are spaced apart from each other along the transverse direction. For example, the plurality of cutting means 220 may be arranged so that a plurality of cutting blades 222 are spaced apart from each other along the transverse direction. In addition, the plurality of cutting means 220 may be spaced apart from each other by a predetermined distance in the transverse direction between a plurality of pressing members 420. For example, the predetermined distance may be an interval where each of the cutting blades 222 is positioned between the chambers 11. In addition, for example, the predetermined distance may be a width of each of the chambers 11 (e.g., a size of each of the plurality of chambers 11 in the transverse direction). In this way, the cover film 12 of the container 10 may be cut for each chamber by the cutting blade 222, and when a user separates some chamber 11 from the container 10, the chamber 11 may be separated while being sealed by the cover film 12.

The plurality of cutting means 220 may be simultaneously moved down in response to the moving down of the supporter 210. In addition, the plurality of cutting means 220 may be independently moved in the vertical direction with respect to the supporter 210. In other words, the plurality of cutting means 220 may be supported from the supporter 210 so that each of the plurality of cutting means 220 are independently movable up and down. For example, the plurality of cutting means 220 may be independently moved in the vertical direction in response to a height difference of the container 10 when cutting the cover film 12, and the plurality of cutting means 220 may cut the cover film 12 at different heights. In this case, although heights between the plurality of chambers 11 are different, the plurality of cutting means 220 may cut the cover film 12 in response to the heights.

Meanwhile, each of the plurality of cutting means 220 may include a cutting frame 221, the cutting blade 222, and the guide pin 223.

The cutting frame 221 may be supported from the supporter 210 so that the cutting frame 221 may be relatively movable in the vertical direction with respect to the supporter 210. In addition, the cutting frame 221 may rotatably support the cutting blade 222. For example, a bearing (not shown) connected to the cutting blade 222 may be equipped in the cutting frame 221, and the cutting blade 222 may be supported from the cutting frame 221 through the bearing. The cutting frame 221 may be spaced apart from the adjacent cutting frame 221 in the transverse direction. In addition, the cutting frame 221 may be supported from the supporter 210 by the stopper 240, and the cutting frame 221 may be prevented from being separated from the supporter 210 by the stopper 240.

Meanwhile, a movement in the vertical direction of the cutting frame 221 may be guided by the guide pin 223. In addition, as the movement in the vertical direction of the cutting frame 221 is guided by the guide pin 223, the cutting frame 221 may be moved up and down while maintaining a level without inclining toward front or rear side. In this case, as the cutting frame 221 maintains the level, the cutting blade 222 may stably cut the cover film 12.

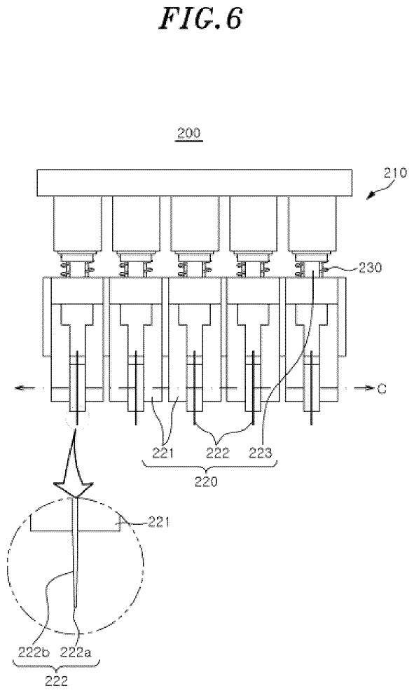

Referring FIG. 6, the cutting blade 222 may cut the cover film 12 into multiple pieces. The cutting blade 222 may cut the cover film 12 by moving from the rear side of the cover film 12 to the front side of the cover film 12 in response to the movement of the cutting frame 221. In addition, the cutting blade 222 may be rotatably supported from the cutting frame 221. That is, the cutting blade 222 may be supported from the cutting frame 221 so as to be freely rotatable a rotation axis, which extends in one direction C, as a rotation center. For example, the cutting blade 222 may be rotated around the rotation axis by the bearing equipped in the cutting frame 221. In addition, the cutting blade 222 may be provided as a circular shape. Meanwhile, the cutting blade 222 may include a cutting edge 222a and an inclined surface 222b.

The cutting edge 222a may be formed in an end of the cutting blade 222, and the cutting edge 222a may extend along an edge of the cutting blade 222 in a circumferential direction. For example, the cutting edge 222a may be a blade portion that cuts the cover film 12 while being in contact with the cover film 12. In addition, the cutting edge 222a may have a predetermined thickness in the transverse direction. The thickness of the cutting edge 222a may be thinner than an interval between adjacent chambers 11. For example, while the cutting blade 222 moves to cut the cover film 12, a part of the cutting edge 222a may be inserted between the adjacent chambers 11, and the cutting blade 222 may be moved forward (or to the front side). In this case, the cover film 12 may be cut by the cutting edge 222a.

The inclined surface 222b may be a portion of the cutting blade 222 other than the cutting edge 222a, and the inclined surface 222b may extend from the cutting edge 222a toward a rotation axis of the cutting blade 222. For example, the inclined surface 222b may be a portion that support the cutting edge 222a. In addition, the inclined surface 222b may be inclined with respect to a direction perpendicular to a direction the rotation axis. That is, the inclined surface 222b may be inclined with respect to a direction perpendicular to a direction where the rotation center of the cutting blade 222 is extended.

Meanwhile, the inclined surface 222b may have a predetermined thickness in the transverse direction, and a thickness of the inclined surface 222b may be greater than a thickness of the cutting edge 222a. In addition, the thickness of the inclined surface 222b may be increased as the inclined surface 222b moves away from the cutting edge 222a. In other words, a thickness of a portion that is adjacent to the cutting edge 222a of the inclined surface 222b may be less than a thickness of a portion that is adjacent to the rotation axis of the inclined surface 222b. In this case, the inclined surface 222b may be supported from the chamber 11 while being inserted between the chambers 11 that is adjacent to a part of the inclined surface 222b. For example, when the cutting edge 222a of the cutting blade 222 is placed between adjacent chambers 11 to cut the cover film 12, the inclined surface 222b may rise along the chamber 11, and the inclined surface 222b may be supported from an upper end of the chamber 11. In this case, the inclined surface 222b passes between the chambers 11 adjacent to the cutting edge 222a, and the inclined surface 222b may be supported from the upper end of the chamber 11 and be moved to the front side while being cut the cover film 12. In other words, the inclined surface 222b may be configured to be in contact with the upper end of the chamber 11 when the cutting edge 222a cuts the cover film 12.

Meanwhile, the cutting blade 222 together with the cutting frame 221 may be moved up and down with respect to the supporter 210. In addition, the cutting blade 222 may rise more when cutting the cover film 12 between the chambers 11 than when cutting the rear end of the container 10. For example, when cutting the rear end of the container 10, the cutting blade 222 may be moved forward while the cutting blade 222 is placed in the first position. In addition, when cutting the cover film 12 between the chambers 11, the cutting blade 222 may rise with the inclined surface 222b supported from the upper end of the chamber 11. In this case, the cutting blade 222 may be brought closer to the supporter 210 than when the cutting blade 222 is placed in the first position. As another example, when the cutting blade 222 passes between the chambers 11, the cutting blade 222 may be moved down with respect to the supporter 210, and the cutting blade 222 may be placed in the first position. In embodiments, the cutting module 200 may be moved forward so that the cover film 12 is cut from the rear end of the cover film 12, and the cutting blade 222 may be moved up more when cutting the cover film 12 between the plurality of chambers 11 than when cutting the rear end of the cover film 12.

The guide pin 223 may prevent the cutting frame 221 from being inclined toward the front or rear side. In other words, although the cutting frame 221 moves up and down with respect to the supporter 210, the guide pin 223 may maintain an inclination of the cutting frame 221 with respect to the supporter 210. The guide pin 223 may be moved in response to the cutting frame 221 in the vertical direction while the guide pin 223 is inserted into the guide hole 212. In addition, the guide pin 223 may be provided as a plurality of guide pins 223, and the plurality of guide pins 223 may be disposed in a front of the stopper 240 and a rear of the stopper 240. For example, the guide pin 223 may be protruded upward from the cutting frame 221. However, it is only an example, and the guide pin 223 may be protruded downward from the supporter 210 and may be inserted into the cutting frame 221.

The elastic member 230 may provide a restoring force to the cutting frame 221 so that the cutting blade 222 is pressed toward the container 10. In addition, the elastic member 230 may provide the restoring force to the cutting mean 220 so that the cutting mean 220 moves in a direction toward the first position, when the plurality of cutting means 220 is displaced from the first position. One side of the elastic member 230 may be supported from a lower portion of the supporter 210, and other side of the elastic member 230 may be supported from an upper portion of the cutting frame 221. In addition, the elastic member 230 may surround at least a part of the stopper 240. For example, the elastic member 230 may be more compressed when the cutting mean 220 is displaced from the first position than when the cutting mean 220 is placed in the first position. In this case, the elastic member 230 may provide the restoring force to the plurality of cutting means 220 so that the cutting mean 220 is moved to the first position. In other words, the elastic member 230 may provide a downward restoring force to the cutting mean 220. The elastic member 230 may be provided as a plurality of elastic members 230, and the plurality of elastic members 230 may be provided to the plurality of cutting means 220, respectively.

The stopper 240 may be selectively caught on the supporter 210 so that the stopper 240 prevents the cutting frame 221 from being separated from the supporter 210. In other words, as the stopper 240 is caught on the supporter 210, the stopper 240 may prevent the cutting frame 221 from being excessively moved down with respect to the supporter 210. For example, an end portion of one side of the stopper 240 may be supported from the supporter 210, when the cutting mean 220 is moved down and is placed in the first position. In addition, when the cutting means 220 rises and is displaced from the first position, the end portion of one side of the stopper 240 may be spaced upward from the supporter 210. A width of the stopper 240 may be less than a width of the support hole 211. In addition, the stopper 240 may be provided as at least one of the cutting frame 221 and the supporter 210. For example, the stopper 240 may be protruded upward from the cutting frame 221. In this case, the stopper 240 may be supported from the supporter 210, when the cutting frame 221 is relatively moved down with respect to the supporter 210. However, it is only an example, the stopper 240 may be protruded from the supporter 210 and may be selectively caught on the cutting frame 221.

The transfer module 300 may move the cutting module 200 along the longitudinal direction. The transfer module 300 may move the cutting module 200 in the longitudinal direction so that the cover film 12 is cut while the pressing module 400 presses the chamber 11 of the container 10. For example, the transfer module 300 may move the cutting module 200 to the front side so that the cover film 12 is cut while the pressing module 400 presses the cover film 12 of the container 10. In addition, the transfer module 300 may move the cutting module 200 to the rear side while the pressing module 400 is spaced apart from the cover film 12 of the container 10. For example, the transfer module 300 may include one or more of a hydraulic cylinder, an LM guide, and a ball screw motor to move the cutting module 200. The transfer module 300 may be coupled to at least one of the pressing module 400 and the base frame 100.

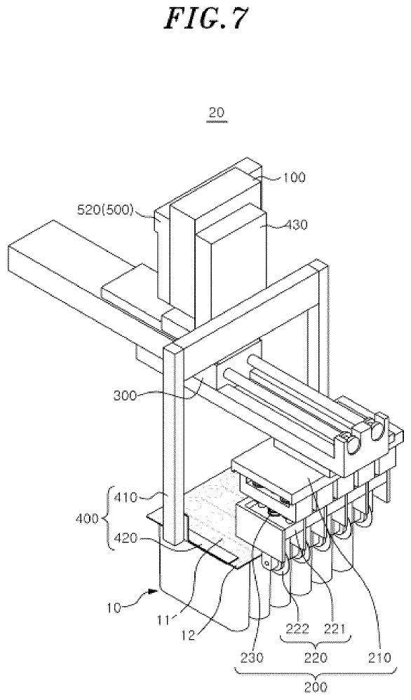

Referring to FIGS. 7 to 9, as the pressing module 400 is moved down, the pressing module 400 may press both lateral portions of the container 10. In other words, as the pressing module 400 is moved down, the pressing module 400 may press downward the chambers 11 located in both lateral portions of the container 10. For example, the container 10 may be the container 10 including the plurality of chambers 11 in the transverse direction. In this case, the chambers 11 located in both lateral portions may be the chambers 11 located in both lateral portions in the transverse direction of the container 10. In addition, the pressing module 400 may be coupled to the base frame 100 and may be movable in the vertical direction on the base frame 100. The pressing module 400 may include a pressing frame 410, a pressing member 420, and a pressing supporter 430.

The pressing frame 410 may be supported from the pressing supporter 430, and the pressing frame 410 may support the pressing member 420. The pressing frame 410 together with the pressing supporter 430 may be relatively moved up and down with respect to the base frame 100. The pressing frame 410 may support a plurality of pressing members 420, and the pressing frame 410 may be configured to be movable in the vertical direction on the base frame 100. For example, the pressing frame 410 may have a ‘[’ shape so that both end portions of the pressing frame 410 is spaced apart from each other in the transverse direction. Meanwhile, in the present specification, the pressing frame 410 is described as being supported from the pressing supporter 430, but this is only an example, and the pressing frame 410 may be movably coupled to the base frame 100.

The pressing member 420 may press downward an upper portion of the cover film 12. The pressing member 420 may be provided as a plurality of pressing members 420, and the plurality of pressing members 420 may be spaced apart from each other along the transverse direction. The plurality of pressing members 420 may be configured to press the cover film 12 attached to the chambers 11 located in both lateral portion of the container 10 when the pressing frame 410 moves down. For example, the pressing member 420 may extend along the longitudinal direction where the cutting module 200 is moved, and the pressing member 420 may have a flat shape. In this case, the pressing member 420 may press the upper portion of the cover film 12 while being in surface contact with the upper portion of the cover film 12.

In addition, the plurality of pressing members 420 may be placed outward from the cutting mean 220, which is located at an outermost side, among the plurality of cutting means 220 in the transverse direction. In addition, the plurality of pressing members 420 may be placed inward from an edge of the chamber 11, which is located at an outermost side, among the plurality of chambers 11 in the transverse direction. As a more detailed example, the plurality of pressing members 420 may be placed further outward than a center of the chamber 11 which is located at the outermost side in the transverse direction. In this case, when the plurality of pressing members 420 press the cover film 12, the cover film 12 may be spread flat.

The pressing supporter 430 may be supported from the base frame 100, and the pressing supporter 430 may support the pressing frame 410. The pressing supporter 430 may be coupled to the base frame 100 and may be movable in the vertical direction. In addition, the pressing supporter 430 may support the transfer module 300. For example, the pressing supporter 430 together with the cutting module 200 and the transfer module 300 may be moved up and down.

The guide unit 500 may guide a movement of the base frame 100. The guide unit 500 may include a guide member 510 and a moving member 520. The guide member 510 may extend in the transverse direction, and the guide member 510 may guide the moving member 520 in the transverse direction. For example, the guide member 510 may be provided as a rail shape so that the moving member 520 is supported from and is slid on the guide member 510. In addition, the base frame 100 may be supported from the moving member 520, and the base frame 100 may be moved by the moving member 520 in the transverse direction.

The driving unit 600 may move the moving member 520 on the guide member 510 in the transverse direction. In addition, the driving unit 600 may move the pressing module 400 on the base frame 100 in the vertical direction. The driving unit 600 may include a plurality of actuators.

The controller 700 may control an operation of the cutting module 200, the transfer module 300, and the pressing module 400. In addition, the controller 700 may control an operation of the driving unit 600. The controller 700 may be implemented by a computing device including a microprocessor, a measuring device such as a sensor, etc., and a memory, and since an implementation method of the controller 700 is obvious to those skilled in the art, a more detailed description is omitted.

Hereinafter, an operation and an effect of the cover film cutting system 1 according to embodiments of the present disclosure will be described.

The film cutting device 20 may cut the cover film 12 of the container 10. For example, as illustrated in FIG. 7, when the container 10 is placed in a predetermined position, the pressing supporter 430 may be moved down so that the pressing member 420 presses the upper portion of the cover film 12. When the pressing member 420 presses the upper portion of the cover film 12, the transfer module 300 may move the cutting module 200 so that the cutting module 200 is moved from the rear side of the container 10 toward the front side of the container 104.

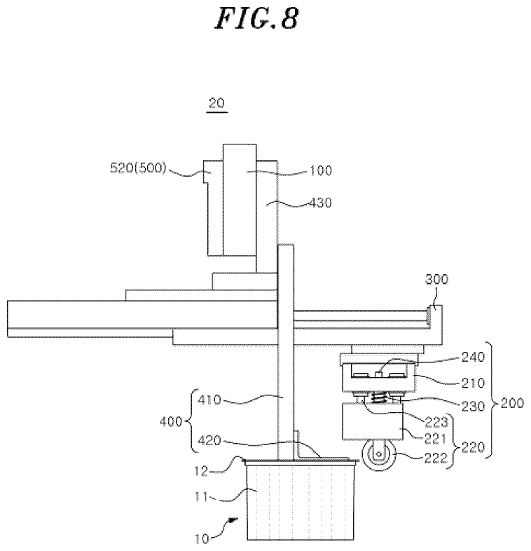

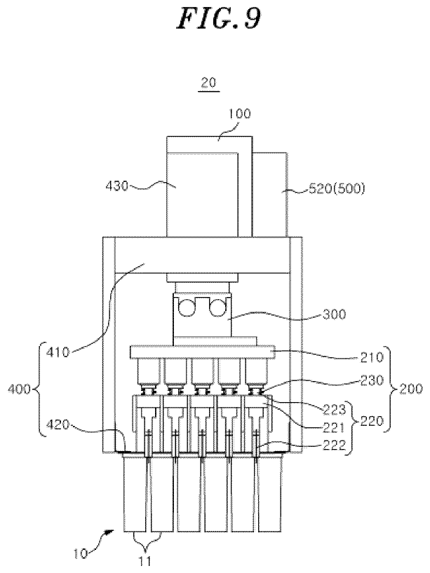

Referring to FIGS. 8 and 9, when the cutting module 200 is placed in the rear side of the container 10, the cutting mean 220 may be placed in the first position, and the cutting mean 220 may be moved toward the front side while being placed in the first position. The cutting blade 222 cut a part of the rear end of the cover film 12 while moving forward, and then cut the cover film 12 between adjacent chambers 11. For example, the cutting blade 222 cuts the rear end of the cover film 12 in an area that is not placed directly on the container 10. In this case, the cutting blade 222 cuts the cover film 12 without an interference from the chamber 11 in a position spaced apart from an edge of the chamber 11.

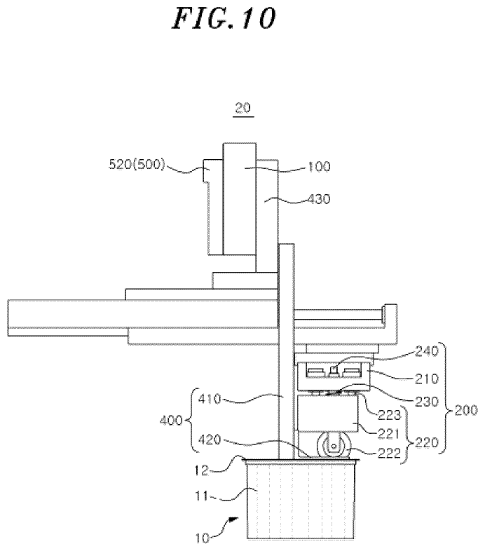

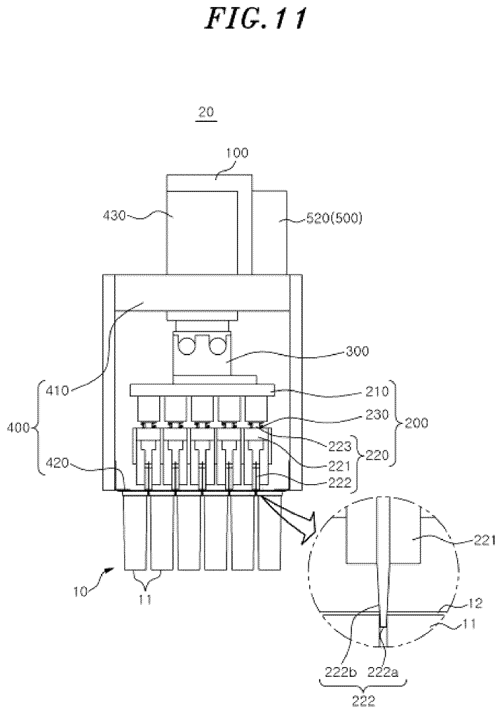

Referring to FIGS. 10 and 11, the cutting mean 220 is moved forward by the transfer module 300, the cutting blade 222 may cut the cover film 12 placed in an upper side of the container 10. For example, when the cutting blade 222 cuts the cover film 12 placed in the upper side of the container 10, the inclined surface 222b rises along the upper end of the chamber 11, and the inclined surface 222b is supported from the upper end of the chamber 11. In this case, the cutting blade 222 rotates around the rotation axis while being supported from the upper end of the chamber 11. In addition, when the cutting blade 222 cuts the cover film 12 placed on the upper side of the container 10, the cutting edge 222a passes between a plurality of adjacent chambers 11 and cuts the cover film 12. In embodiments, while the cutting module 200 is moved forward, the cutting blade 222 is rotated by being in contact with the upper end of the chamber 11 after the cutting blade 222 cuts a part of the rear end of the cover film 12.

Afterwards, when the cutting blade 222 is moved forward and passes between the plurality of adjacent chambers 11, the cutting mean 220 is moved down with respect to the supporter 210 by the restoring force of the elastic member 230. In addition, when the cover film 12 is cut by the plurality of cutting means 220, the chamber 11 may be separated from each other.

Meanwhile, when cover film 12 seals the plurality of chambers 11, an upper portion of a gap between the plurality of chambers 11 sealed with the cover film 12 becomes narrower due to a heat shrinkage of the cover film 12, and a lower portion, which is opposite to the upper portion, of the gap becomes wider. The cover film 12 may be bent. In this case, as the cutting module 200 cuts the cover film 12 while the plurality of pressing members 420 press both lateral portions of the container 10 so that the cover film 12 becomes flat, the film cutting device 20 has an effect capable of evenly cutting the cover film 12 into multiple pieces.

In addition, the plurality of cutting means 220 is configured to be independently movable up on the supporter 210, and there is an effect that may prevent the cover film 12 from being cut unevenly due to height differences between the chambers 11.

In addition, as the cutting blade 222 may rotate freely and is provided in a circular shape, there is an effect that may prevent the cutting blade 222 from being damaged when the cutting blade 222 cuts the cover film 12.

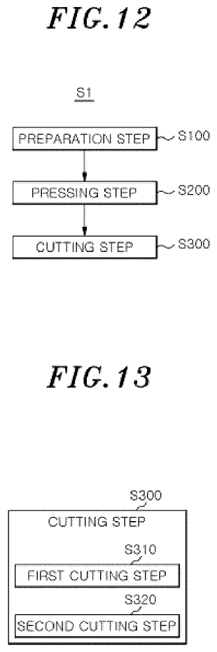

Hereinafter, referring to FIGS. 12 and 13, a method S10 of cutting the cover film 12 of the container 10 using the film cutting device 20 according to embodiments of a present disclosure will be described. The method S10 may cut the cover film 12 sealing the container 10. For example, the cover film 12 of the container 10 is cut by using the film cutting device 20. The method S10 may include a preparation step S100, a pressing step S200, and a cutting step S300.

The preparation step S100 may prepare the container 10 so that the film cutting device 20 is positioned adjacent to the container 10 where the plurality of chambers 11 are sealed with the cover film 12. In the preparation step S100, the film cutting device 20 may be spaced apart from the container 10, and the plurality of cutting means 220 may be placed in the first position.

The pressing step S200 may press the container 10 by moving down the pressing module 400. For example, in the pressurizing step S200, the pressing supporter 430 moves down along the base frame 100, and the pressing frame 410 and the pressing member 420 which are supported from the pressing supporter 430 are moved down together with the pressing supporter 430. For example, the plurality of pressing members 420 may move down to pressurize the cover film 12 attached to the chambers 11, which are located in both lateral portions of the container 10, among the plurality of chambers 11. In this case, the bent cover film 12 may be spread flat by the pressing member 420 before the pressing member 420 pressurize the container 10. The chambers 11 located in both lateral portions may be the chambers 11 located in both lateral portions of the container 10 in the transverse direction.

The cutting step S300 may cut the cover film 12 attached to the container 10 by moving the cutting module 200 by the transfer module 300. In the cutting step S300, the cutting module 200 may cut the cover film 12 while moving from the rear side of the container 10 toward the front side of the container 10. The transfer module 300 may cut the cover film 12 attached to the container 10 by moving the cutting module 200 between the plurality of pressing members 420.

In addition, the cutting step S300 may be performed after the pressing step S200. The cutting step S300 may include a first cutting step S310 and a second cutting step S320.

In the first cutting step S310, the cutting module 200 may cut a part of the rear end of the cover film 12. For example, when a size of the cover film 12 is greater than a size of the upper portion of the plurality of chambers 11, an edge of the cover film 12 is placed outside of an edge of the chamber 11. In this case, the cutting blade 222 cuts the rear end of the cover film 12 in a position spaced apart from the edge of the chamber 11 without an interference from the chamber 11. In addition, in the first cutting step S310, the cutting blade 222 moves while being placed in the first position, and cuts the cover film 12 while a height of the cutting blade 222 is maintained.

In the second cutting step S320, the cutting module 200 may cut the cover film 12 between the plurality of chambers 11. In addition, the cutting blade 222 in the second cutting step S320 may move higher than the cutting blade 222 in the first cutting step S310, and may be rotated by being in contact with the upper end of the chamber 11. For example, when being changed from the first cutting step S310 to the second cutting step S320, the inclined surface 222b of the cutting blade 222 rises along the upper end of the chamber 11, and is rotated while being supported from the upper end of the chamber 11. In this case, the cutting edge 222a moves between adjacent chambers 11 and cuts the cover film 12. In addition, the cutting frame 221 also rise toward the supporter 210 due to the rise of the cutting blade 222. When the cutting step S300 is completed, the cutting mean 220 moves down to the first position by the elastic member 230.

Although the embodiments of the present disclosure have been described as specific embodiments, they are merely examples, and the present disclosure is not limited thereto, but should be interpreted to have the widest scope according to the technical idea disclosed in this specification. Those skilled in the art may implement a pattern of a shape not specified by combining/substituting the disclosed embodiments, but this also does not go beyond the scope of the present disclosure. In addition, those skilled in the art may easily change or modify the disclosed embodiments based on this specification, and it is clear that such changes or modifications also fall within the scope of the rights of the present disclosure.

What is claimed is:

1. A film cutting device for cutting a cover film attached to a container including a plurality of chambers that are detachably connected to each other, the film cutting device comprising:
a base frame;
a pressing module coupled to the base frame to be movable in a vertical direction, the pressing module being configured to move down and press downward the chambers located in both lateral portions of the container;
a transfer module coupled to at least one of the pressing module and the base frame; and
a cutting module coupled to transfer module,
wherein the cutting module includes a plurality of cutting means capable of cutting the cover film attached to the container, and
wherein the transfer module is configured to move the cutting module in a longitudinal direction so that the cover film is cut while the pressing module presses the chamber of the container.

2. The film cutting device of claim 1, wherein the plurality of chambers are connected to each other so that the plurality of chambers are arranged in a transverse direction.

3. The film cutting device of claim 1, wherein the cutting module further includes a supporter supporting the plurality of cutting means, and
wherein each of the plurality of cutting means includes:
a cutting frame supported from the supporter to be able to move up and down with respect to the supporter; and
a cutting blade supported from the cutting frame.

4. The film cutting device of claim 3, wherein the plurality of cutting means are spaced apart from each other and are supported from the supporter so that the plurality of cutting means are independently move up and down relative to each other.

5. The film cutting device of claim 3, wherein the cutting module further includes a plurality of elastic member providing a restoring force to the cutting frame so that the cutting blade is pressed toward the container.

6. The film cutting device of claim 5, wherein one side of the elastic member is supported from the supporter, and other side of the elastic member is supported from the cutting frame.

7. The film cutting device of claim 5, wherein a stopper is provided to at least one of the cutting frame and the supporter, and the stopper prevents the cutting frame from being separated from the supporter.

8. The film cutting device of claim 7, wherein the stopper is protruded upward from the cutting frame, and the stopper is supported from the supporter when the cutting frame is relatively moved down with respect to the supporter.

9. The film cutting device of claim 3, wherein the cutting blade is supported from the cutting frame so that the cutting blade is rotatable.

10. The film cutting device of claim 9, wherein the cutting module is moved forward so that the cover film is cut from a rear end of the cover film, and
wherein the cutting blade moves up more when cutting the cover film between the plurality of chambers than when cutting the rear end of the cover film.

11. The film cutting device of claim 10, wherein while the cutting module is moved forward, the cutting blade cuts a part of the rear end of the cover film and is rotated by being in contact with an upper end of the chamber.

12. The film cutting device of claim 11, wherein the cutting blade includes:
a cutting edge provided at an end of the cutting blade; and
an inclined surface extending from the cutting edge toward a rotation axis of the cutting blade,
wherein the inclined surface is inclined with respect to a direction that is perpendicular to a direction of the rotation axis, and
wherein when the cutting edge cuts the cover film, the inclined surface is in contact with the upper end of the chamber.

13. The film cutting device of claim 9, wherein the cutting blade has a circular shape.

14. The film cutting device of claim 3, wherein the pressing module includes:
a plurality of pressing members are spaced apart from each other along a transverse direction of the cutting means, the plurality of pressing members being capable of pressing an upper portion of the cover film; and
a pressing frame supporting the plurality of pressing members, the pressing frame being configured to be movable in the vertical direction on the base frame,
wherein the plurality of pressing members presses the cover film attached to the chambers located in both lateral portions of the container, when the pressing frame moves down.

15. The film cutting device of claim 14, wherein the plurality of cutting means are spaced apart from each other by a predetermined distance between the plurality of pressing members so that each of the cutting blades is located between the chambers.

16. The film cutting device of claim 14, wherein the plurality of pressing members extend along the longitudinal direction, and each of the plurality of pressing members have a flat shape.

17. The film cutting device of claim 3, wherein the plurality of chambers are arranged in a transverse direction, and the cutting blade is configured to cut the cover film with a part of the cutting blade inserted between the plurality of chambers.

18. A method of cutting a cover film of a container, the method comprising:
(a) a preparation step of positioning a container in a film cutting device;
wherein the container includes a plurality of chambers that are detachably connected to each other, and the film cutting device comprising:
a base frame;
a pressing module coupled to the base frame to be movable in a vertical direction, the pressing module being configured to move down and press downward the chambers located in both lateral portions of the container;
a transfer module coupled to at least one of the pressing module and the base frame; and
a cutting module coupled to transfer module,
wherein the cutting module includes a plurality of cutting means capable of cutting the cover film attached to the container, and
wherein the transfer module is configured to move the cutting module in a longitudinal direction so that the cover film is cut while the pressing module presses the chamber of the container,
(b) a pressing step of pressing the chambers located in both lateral portions of the container by moving down the pressing module; and
(c) a cutting step of cover film attached to the container after the cutting module is moved by the transfer module.

19. The method of claim 18, wherein (c) the cutting step is performed after (b) the pressing step.

20. The method of claim 18, wherein (c) the cutting step includes:
a first cutting step where the cutting module cuts a rear end of the cover film; and
a second cutting step where the cutting module cuts the cover film between the plurality of chambers,
wherein the cutting module is moved forward so that the cover film is cut from the rear end of the cover film, and the cutting module includes a cutting blade, and
wherein the cutting blade moves up more in the second cutting step than the first cutting step.

21. The method of claim 20, wherein the cutting blade is spaced apart from the chamber in the first cutting step, and the cutting blade is rotated by being in contact with an upper end of the chamber in the second cutting step.

22. The method of claim 18, wherein the pressing module includes a plurality of pressing members spaced apart from each other along a transverse direction of the cutting means,
wherein the container includes a plurality of chambers arranged in the transverse direction, and
wherein in (b) the pressing step, the plurality of pressing members press the cover film attached to chambers, which is located in both lateral portions of the container, among the plurality of chambers by moving down the plurality of pressing members.

23. The method of claim 22, wherein in (c) the cutting step, the transfer module moves the cutting module between the plurality of pressing members, and the transfer module cuts the cover film attached to the container.
